(19) United States
(12) Patent Application Publication
(10) Pub. No.: US 2025/0378030 A1
(43) Pub. Date: Dec. 11, 2025

(54) TECHNIQUES AND SYSTEMS FOR EMULATING INCOHERENT MEMORY

(71) Applicant: Micron Technology, Inc., Boise, ID (US)

(72) Inventors: Patrick ESTEP, Rowlett, TX (US); Tony M. BREWER, Plano, TX (US); Bashar ROMANOUS, Allen, TX (US); Skyler A. WINDH, McKinney, TX (US)

(21) Appl. No.: 19/184,564

(22) Filed: Apr. 21, 2025

Related U.S. Application Data
(60) Provisional application No. 63/657,476, filed on Jun. 7, 2024.

(51) Int. Cl. G06F 12/0815

(52) U.S. Cl. CPC G06F 12/0815

(57) ABSTRACT

In some implementations, an emulation system may store a set of data to a first memory copy location of an emulated environment that is associated with a first virtual host system. The emulation system may copy the set of data from the first memory copy location to a shared memory location of the emulated environment. The emulation system may copy the set of data from the shared memory location to a second memory copy location of the emulated environment that is associated with a second virtual host system. The emulation system may load the set of data from the second memory copy location.

### CROSS-REFERENCE TO RELATED APPLICATION

This patent application claims priority to U.S. Provisional Patent Application No. 63/657,476, filed on Jun. 7, 2024, entitled “TECHNIQUES AND SYSTEMS FOR EMULATING INCOHERENT MEMORY,” and assigned to the assignee hereof. The disclosure of the prior application is considered part of and is incorporated by reference into this patent application.

### TECHNICAL FIELD

The present disclosure generally relates to memory devices, memory device operations, and, for example, to techniques and systems for emulating incoherent memory.

### BACKGROUND

Memory devices are widely used to store information in various electronic devices. A memory device includes memory cells. A memory cell is an electronic circuit capable of being programmed to a data state of two or more data states. For example, a memory cell may be programmed to a data state that represents a single binary value, often denoted by a binary “1” or a binary “0.” As another example, a memory cell may be programmed to a data state that represents a fractional value (e.g., 0.5, or 1.5, among other examples). To store information, an electronic device may write to, or program, a set of memory cells. To access the stored information, the electronic device may read, or sense, the stored state from the set of memory cells.

Various types of memory devices exist, including random access memory (RAM), read only memory (ROM), dynamic RAM (DRAM), static RAM (SRAM), synchronous DRAM (SDRAM), ferroelectric RAM (FeRAM), magnetic RAM (MRAM), resistive RAM (RRAM), holographic RAM (HRAM), flash memory (e.g., NAND memory and NOR memory), and others. A memory device may be volatile or non-volatile. Non-volatile memory (e.g., flash memory) can store data for extended periods of time even in the absence of an external power source. Volatile memory (e.g., DRAM) may lose stored data over time unless the volatile memory is refreshed by a power source. In some examples, a memory device may be associated with memory resources that may be accessed by various processes running on different physical or virtual hosts. In such systems, software-level solutions for memory coherence are often employed to ensure that data remains consistent and reliable when accessed by concurrent processes.

### BRIEF DESCRIPTION OF THE DRAWINGS

FIG. 1 is a diagram illustrating an example system associated with emulating incoherent memory.

FIG. 2 is a diagram illustrating another example system associated with emulating incoherent memory.

FIGS. 3A-3B are diagrams of examples associated with software coherency primitives for memory systems.

FIG. 4 is a diagram of an example emulation system that may enable emulation of incoherent memory.

FIG. 5 is a flowchart of an example method associated with techniques and systems for emulating incoherent memory.

### DETAILED DESCRIPTION

Recent advancements in computing have led to the development of global shared memory paradigms that enable load/store access sharing between servers and/or similar devices, such as compute express link (CXL) global shared memory. This technology enables shared memory clusters where memory coherency (e.g., the consistency of shared resource data) is a fundamental concern. While CXL promises hardware-based memory coherency in the future, current implementations rely heavily on software-based coherency protocols to guarantee coherent memory access.

However, the scarcity of CXL hardware has necessitated the development of emulated environments on single servers using virtualization technologies, where multiple virtual machines simulate a cluster of servers with memory devices attached via CXL fabric. In these single server setups, inherent hardware coherency masks the absence or incorrect implementation of software coherency primitives in tests or applications due to the hardware coherency across virtual machines. As a result, developers may receive correct answers in the emulated environment, only to face failures when deploying applications in a physical, multi-server shared memory environment where hardware-based coherency does not exist, and software-based protocols are necessary. Without a reliable method to simulate the absence of hardware-based coherency, there is a risk that applications may not be rigorously tested against all scenarios they would encounter in real-world deployments.

Some implementations described herein are associated with a methodology to emulate incoherent memory in a virtualized environment, such as for a purpose of validating software coherency primitives. The implementations described herein involve a series of operations including storing data to a first memory copy location at a first virtual host system within an emulated environment, copying the stored data to a shared memory location that is accessible by multiple virtual host systems, duplicating the data from the shared memory location to a second memory copy location tied to a second virtual host system, and loading the data at the second virtual host from its second memory copy location. In certain implementations, the techniques described herein may be expanded to encompass the determination of errors in software coherency primitives by comparing the data loaded from the second memory copy location with the original data stored to the first memory copy location. For example, the techniques described herein may be used to detect errors in one or more software coherency primitives associated with an application that produces correct results when implemented across a hardware coherent memory cluster.

In that regard, implementations described herein may enable emulation of incoherent memory behavior, such as for a purpose of replicating the conditions that necessitate the use of software coherency in environments where hardware coherency is absent, such as in physical multi-server shared memory configurations. This emulation ensures that for any virtual host to access up-to-date data, the software coherency primitives must be correctly executed, thus enforcing precision and robustness in software design and implementation. In this way, the implementations described herein enable a more thorough and realistic verification environment for software coherency primitives. Through meticulous testing made possible by the implementations described herein, developers may accurately pinpoint and resolve coherency issues, leading to software systems that are more reliable and maintainable. Furthermore, the implementations described herein may conserve processing and memory resources that might otherwise be expended in troubleshooting and addressing problems stemming from improperly implemented coherency primitives in a less controlled testing scenario.

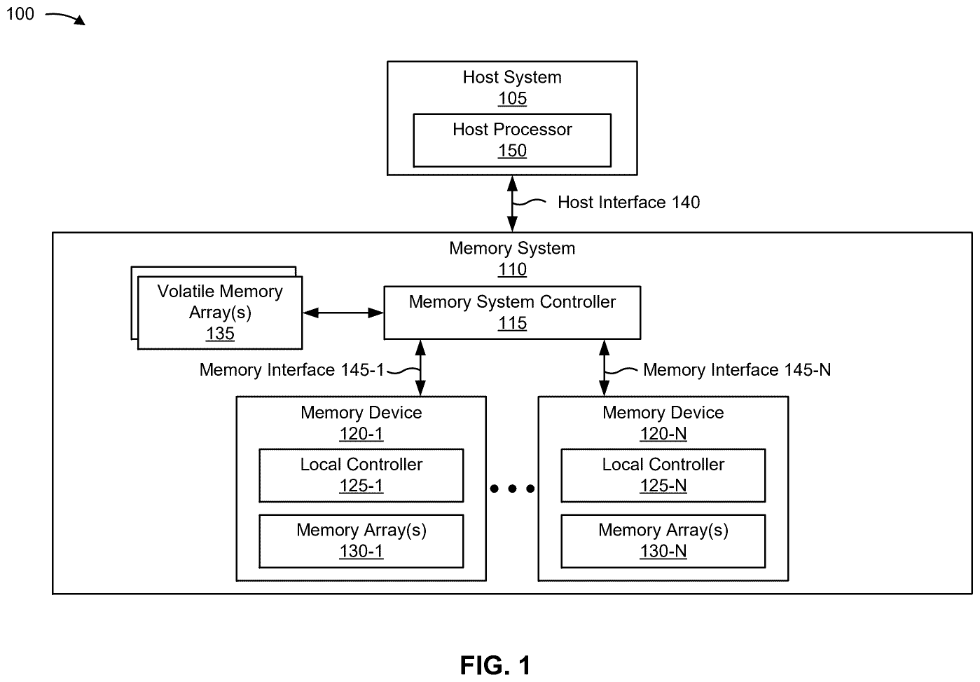

FIG. 1 is a diagram illustrating an example system 100 associated with emulating incoherent memory. The system 100 may include one or more devices, apparatuses, and/or components for performing operations described herein. For example, the system 100 may include a host system 105 and a memory system 110. The memory system 110 may include a memory system controller 115 and one or more memory devices 120, shown as memory devices 120-1 through 120-N (where N≥1). A memory device may include a local controller 125 and one or more memory arrays 130. The host system 105 may communicate with the memory system 110 (e.g., the memory system controller 115 of the memory system 110) via a host interface 140. The memory system controller 115 and the memory devices 120 may communicate via respective memory interfaces 145, shown as memory interfaces 145-1 through 145-N (where N≥1).

The system 100 may be any electronic device configured to store data in memory. For example, the system 100 may be a computer, a mobile phone, a wired or wireless communication device, a network device, a server, a device in a data center, a device in a cloud computing environment, a vehicle (e.g., an automobile or an airplane), and/or an Internet of Things (IoT) device. The host system 105 may include a host processor 150. The host processor 150 may include one or more processors configured to execute instructions and store data in the memory system 110. For example, the host processor 150 may include a central processing unit (CPU), a graphics processing unit (GPU), a field-programmable gate array (FPGA), an application-specific integrated circuit (ASIC), and/or another type of processing component.

The memory system 110 may be any electronic device or apparatus configured to store data in memory. For example, the memory system 110 may be a hard drive, a solid-state drive (SSD), a flash memory system (e.g., a NAND flash memory system or a NOR flash memory system), a universal serial bus (USB) drive, a memory card (e.g., a secure digital (SD) card), a secondary storage device, a non-volatile memory express (NVMe) device, an embedded multimedia card (eMMC) device, a dual in-line memory module (DIMM), a CXL memory module, and/or a random-access memory (RAM) device, such as a dynamic RAM (DRAM) device or a static RAM (SRAM) device.

The memory system controller 115 may be any device configured to control operations of the memory system 110 and/or operations of the memory devices 120. For example, the memory system controller 115 may include control logic, a memory controller, a system controller, an ASIC, an FPGA, a processor, a microcontroller, and/or one or more processing components. In some implementations, the memory system controller 115 may communicate with the host system 105 and may instruct one or more memory devices 120 regarding memory operations to be performed by those one or more memory devices 120 based on one or more instructions from the host system 105. For example, the memory system controller 115 may provide instructions to a local controller 125 regarding memory operations to be performed by the local controller 125 in connection with a corresponding memory device 120.

A memory device 120 may include a local controller 125 and one or more memory arrays 130. In some implementations, a memory device 120 includes a single memory array 130. In some implementations, each memory device 120 of the memory system 110 may be implemented in a separate semiconductor package or on a separate die that includes a respective local controller 125 and a respective memory array 130 of that memory device 120. The memory system 110 may include multiple memory devices 120.

A local controller 125 may be any device configured to control memory operations of a memory device 120 within which the local controller 125 is included (e.g., and not to control memory operations of other memory devices 120). For example, the local controller 125 may include control logic, a memory controller, a system controller, an ASIC, an FPGA, a processor, a microcontroller, a CXL controller connected to DRAM, and/or one or more processing components. In some implementations, the local controller 125 may communicate with the memory system controller 115 and may control operations performed on a memory array 130 coupled with the local controller 125 based on one or more instructions from the memory system controller 115. As an example, the memory system controller 115 may be an SSD controller, and the local controller 125 may be a NAND controller.

A memory array 130 may include an array of memory cells configured to store data. For example, a memory array 130 may include a non-volatile memory array (e.g., a NAND memory array or a NOR memory array) or a volatile memory array (e.g., an SRAM array or a DRAM array). In some implementations, the memory system 110 may include one or more volatile memory arrays 135. A volatile memory array 135 may include an SRAM array and/or a DRAM array, among other examples. The one or more volatile memory arrays 135 may be included in the memory system controller 115, in one or more memory devices 120, and/or in both the memory system controller 115 and one or more memory devices 120. In some implementations, the memory system 110 may include both non-volatile memory capable of maintaining stored data after the memory system 110 is powered off and volatile memory (e.g., a volatile memory array 135) that requires power to maintain stored data and that loses stored data after the memory system 110 is powered off. For example, a volatile memory array 135 may cache data read from or to be written to non-volatile memory, and/or may cache instructions to be executed by a controller of the memory system 110.

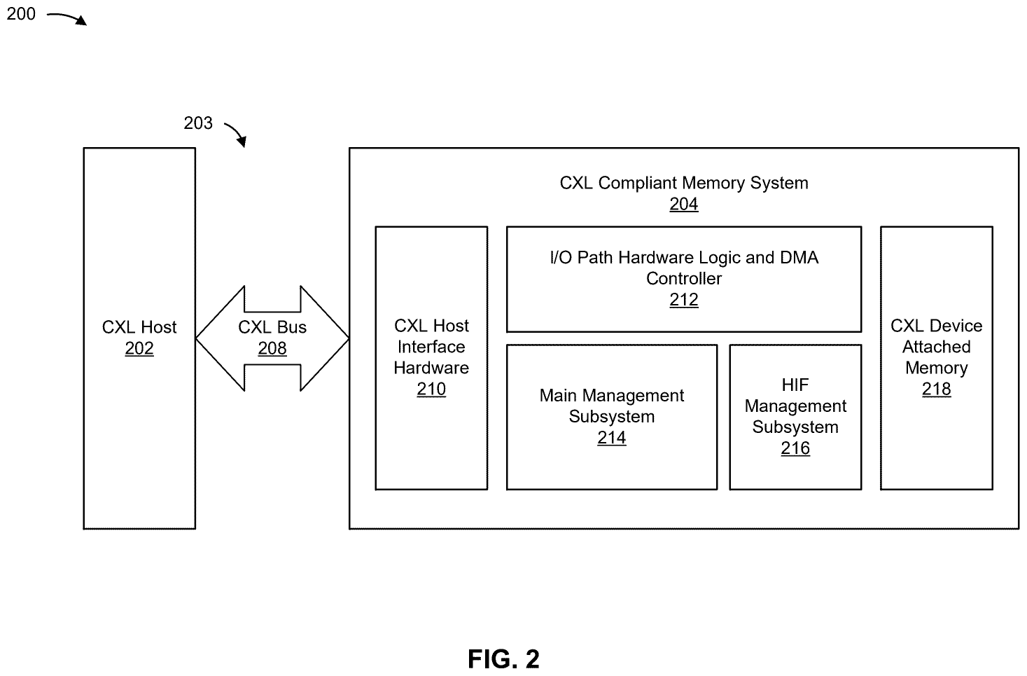

The host interface 140 enables communication between the host system 105 (e.g., the host processor 150) and the memory system 110 (e.g., the memory system controller 115). The host interface 140 may include, for example, a Small Computer System Interface (SCSI), a Serial-Attached SCSI (SAS), a Serial Advanced Technology Attachment (SATA) interface, a Peripheral Component Interconnect Express (PCIe) interface, an NVMe interface, a USB interface, a Universal Flash Storage (UFS) interface, an eMMC interface, a double data rate (DDR) interface, a DIMM interface, and/or a CXL interface (e.g., a PCIe/CXL interface, described in more detail below in connection with FIG. 2).

The memory interface 145 enables communication between the memory system 110 and the memory device 120. The memory interface 145 may include a non-volatile memory interface (e.g., for communicating with non-volatile memory), such as a NAND interface or a NOR interface. Additionally, or alternatively, the memory interface 145 may include a volatile memory interface (e.g., for communicating with volatile memory), such as a DDR interface.

Although the example memory system 110 described above includes a memory system controller 115, in some implementations, the memory system 110 does not include a memory system controller 115. For example, an external controller (e.g., included in the host system 105) and/or one or more local controllers 125 included in one or more corresponding memory devices 120 may perform the operations described herein as being performed by the memory system controller 115. Furthermore, as used herein, a “controller” may refer to the memory system controller 115, a local controller 125, or an external controller. In some implementations, a set of operations described herein as being performed by a controller may be performed by a single controller. For example, the entire set of operations may be performed by a single memory system controller 115, a single local controller 125, or a single external controller. Alternatively, a set of operations described herein as being performed by a controller may be performed by more than one controller. For example, a first subset of the operations may be performed by the memory system controller 115 and a second subset of the operations may be performed by a local controller 125. Furthermore, the term “memory apparatus” may refer to the memory system 110 or a memory device 120, depending on the context.

A controller (e.g., the memory system controller 115, a local controller 125, or an external controller) may control operations performed on memory (e.g., a memory array 130), such as by executing one or more instructions. For example, the memory system 110 and/or a memory device 120 may store one or more instructions in memory as firmware, and the controller may execute those one or more instructions. Additionally, or alternatively, the controller may receive one or more instructions from the host system 105 and/or from the memory system controller 115, and may execute those one or more instructions. In some implementations, a non-transitory computer-readable medium (e.g., volatile memory and/or non-volatile memory) may store a set of instructions (e.g., one or more instructions or code) for execution by the controller. The controller may execute the set of instructions to perform one or more operations or methods described herein. In some implementations, execution of the set of instructions, by the controller, causes the controller, the memory system 110, and/or a memory device 120 to perform one or more operations or methods described herein. In some implementations, hardwired circuitry is used instead of or in combination with the one or more instructions to perform one or more operations or methods described herein. Additionally, or alternatively, the controller may be configured to perform one or more operations or methods described herein. An instruction is sometimes called a “command.”

For example, the controller (e.g., the memory system controller 115, a local controller 125, or an external controller) may transmit signals to and/or receive signals from memory (e.g., one or more memory arrays 130) based on the one or more instructions, such as to transfer data to (e.g., write or program), to transfer data from (e.g., read), to erase, and/or to refresh all or a portion of the memory (e.g., one or more memory cells, pages, sub-blocks, blocks, or planes of the memory). Additionally, or alternatively, the controller may be configured to control access to the memory and/or to provide a translation layer between the host system 105 and the memory (e.g., for mapping logical addresses to physical addresses of a memory array 130). In some implementations, the controller may translate a host interface command (e.g., a command received from the host system 105) into a memory interface command (e.g., a command for performing an operation on a memory array 130).

In some implementations, one or more systems, devices, apparatuses, components, and/or controllers of FIG. 1 may be configured to copy a set of data from a first memory copy location to a shared memory location, wherein the first memory copy location is a memory location associated with the first virtual host system; and copy, by one or more second virtual host systems, the set of data from the shared memory location to one or more second memory copy locations associated with the one or more second virtual host systems.

In some implementations, one or more systems, devices, apparatuses, components, and/or controllers of FIG. 1 may be configured to store a set of data to a first memory copy location of an emulated environment that is associated with a first virtual host system; copy the set of data from the first memory copy location to a shared memory location of the emulated environment; copy the set of data from the shared memory location to a second memory copy location of the emulated environment that is associated with a second virtual host system; and load the set of data from the second memory copy location.

In some implementations, one or more systems, devices, apparatuses, components, and/or controllers of FIG. 1 may be configured to store a set of data to a first local memory location associated with the first virtual CXL compliant host; copy the set of data from the first local memory location to a shared direct-access memory location; copy the set of data from the shared direct-access memory location to a second local memory location associated with the second virtual CXL compliant host; and load the set of data from the second local memory location.

The number and arrangement of components shown in FIG. 1 are provided as an example. In practice, there may be additional components, fewer components, different components, or differently arranged components than those shown in FIG. 1. Furthermore, two or more components shown in FIG. 1 may be implemented within a single component, or a single component shown in FIG. 1 may be implemented as multiple, distributed components. Additionally, or alternatively, a set of components (e.g., one or more components) shown in FIG. 1 may perform one or more operations described as being performed by another set of components shown in FIG. 1.

FIG. 2 is a diagram illustrating another example system 200 associated with emulating incoherent memory. The system 200 may include one or more devices, apparatuses, and/or components for performing operations described herein. In some examples, the system 200 may be associated with a CXL standard and/or protocol (e.g., the system 200 may utilize a CXL protocol to communicate between a host device, sometimes referred to as a CXL compliant host or simply a CXL host, and a memory system, sometimes referred to as a CXL compliant memory system or simply a CXL memory system). In that regard, the system 200 may include a CXL host 202 (which may correspond to the host system 105) and a CXL compliant memory system 204 (which may correspond to the memory system 110). The CXL host 202 and the CXL compliant memory system 204 may communicate via an interface 203 (e.g., host interface 140), which may include a CXL bus 208 (e.g., a PCIe/CXL interface), among other examples.

In some examples, the CXL compliant memory system 204 may be a system that complies with the CXL standard and/or protocol, such as for a purpose of communicating with one or more host devices (e.g., a CXL compliant host, such as CXL host 202). CXL is an open standard that may enable high-speed CPU-to-device and CPU-to-memory interconnects designed to accelerate next-generation performance. The CXL standard may enable memory coherency between the CPU memory space and memory on attached devices, which allows resource sharing for higher performance, reduced software stack complexity, and lower overall system cost. CXL is designed to be an industry open standard for enabling an interface for high-speed communications. CXL technology utilizes the PCIe infrastructure, leveraging PCIe physical and electrical interfaces to provide an advanced protocol in areas such as input/output (I/O) protocol, memory protocol, and coherency interface.

In some examples, the system 200 may include a PCIe/CXL interface (e.g., the CXL bus 208 may be associated with a PCIe/CXL interface), which may be a physical interface configured to connect the CXL compliant memory system 204 to CXL compliant host devices, such as the CXL host 202. In such examples, the PCIe/CXL interface may comply with CXL standard specifications for physical connectivity, ensuring broad compatibility and ease of integration into existing systems using the CXL protocol. Additionally, or alternatively, the CXL compliant memory system 204 may be designed to efficiently interface with computing systems (e.g., CXL host 202 and/or a host system 105) by leveraging the CXL protocol. For example, the CXL compliant memory system 204 may be configured to utilize high-speed, low-latency interconnect capabilities of CXL, such as for a purpose of making the CXL compliant memory system 204 suitable for high-performance computing, data center applications, artificial intelligence (AI) applications, and/or similar applications.

In some examples, the CXL compliant memory system 204 may include a CXL memory system controller (e.g., a CXL ASIC, which may correspond to the memory system controller 115 and/or local controller 125), which may be configured to manage data flow between memory arrays (shown as CXL device attached memory 218, which may correspond to the volatile memory arrays 135 and/or the memory arrays 130) and a CXL interface (e.g., the CXL bus 208). In some examples, the CXL memory system controller may be configured to handle one or more CXL protocol layers, such as an I/O layer (e.g., a layer associated with a CXL.io protocol, which may be used for purposes such as device discovery, configuration, initialization, I/O virtualization, direct memory access (DMA) using non-coherent load-store semantics, and/or similar purposes); a cache coherency layer (e.g., a layer associated with a CXL.cache protocol, which may be used for purposes such as caching host memory using a modified, exclusive, shared, invalid (MESI) coherence protocol, or similar purposes); or a memory protocol layer (e.g., a layer associated with a CXL.memory (sometimes referred to as CXL.mem) protocol, which may enable a CXL memory device to expose host-managed device memory (HDM) to permit a host device to manage and access memory similar to a native DDR connected to the host); among other examples.

The CXL compliant memory system 204 may further include and/or be associated with one or more high-bandwidth memory modules (HBMMs) or similar memory arrays (e.g., CXL device attached memory 218). For example, the CXL compliant memory system 204 may include multiple layers of DRAM (e.g., stacked and/or interconnected through advanced through-silicon via (TSV) technology) in order to maximize storage density and/or enhance data transfer speeds between memory layers. Additionally, or alternatively, the CXL compliant memory system 204 (e.g., a CXL ASIC of the CXL compliant memory system 204) may include a power management unit, which may be configured to regulate power consumption associated with the CXL compliant memory system 204 and/or which may be configured to improve energy efficiency for the CXL compliant memory system 204. Additionally, or alternatively, the CXL compliant memory system 204 (e.g., a CXL ASIC of the CXL compliant memory system 204) may include additional components, such as one or more error correction code (ECC) engines, such as for a purpose of detecting and/or correcting data errors to ensure data integrity and/or improve the overall reliability of the CXL compliant memory system 204. The CXL compliant memory system 204 may be implemented using a combination of hardware and firmware blocks and/or components. In such examples, the firmware may execute on one or more embedded CPUs within the CXL compliant memory system 204.

Additionally, or alternatively, the CXL compliant memory system 204 and/or a CXL memory system controller (e.g., a CXL ASIC) of the CXL compliant memory system 204 may include CXL host interface hardware 210, an I/O path hardware logic and DMA controller 212, a main management subsystem 214, and/or a host interface (HIF) management subsystem 216, among other examples. In some examples, the CXL host interface hardware 210 may be hardware components that enable physical connectivity between the CXL compliant memory system 204 and one or more external devices, such as to the CXL host 202 via the CXL bus 208. In some examples, the CXL host interface hardware 210 may include the necessary physical interfaces and protocol logic required to establish and/or maintain communication over the CXL link (e.g., via the CXL bus 208). In some cases, the CXL host interface hardware 210 may ensure that the CXL host 202 can access and/or control the CXL compliant memory system 204 efficiently.

The I/O path hardware logic and DMA controller 212 may handle data transfers between the CXL compliant memory system 204 and external devices, such as other memory modules and/or peripheral components. In some examples, a DMA controller portion of the I/O path hardware logic and DMA controller 212 may permit efficient data transfer without involving a CXL compliant memory system 204 CPU, directly. Put another way, the DMA controller portion of the I/O path hardware logic and DMA controller 212 may manage data movement between the CXL compliant memory system 204 and other system components, which may enhance overall system performance by offloading data transfer tasks from the CPU.

The main management subsystem 214 may serve as a central control and management unit within the CXL compliant memory system 204. In some examples, the main management subsystem 214 may encompass various functionalities and tasks, such as memory access control, error detection and/or correction, power management, and/or similar system management functionalities and/or tasks. Additionally, or alternatively, the main management subsystem 214 may ensure proper functioning and/or reliability of the CXL compliant memory system 204 and/or may optimize the performance of the CXL compliant memory system 204 under various operating conditions.

The HIF management subsystem 216 may be responsible for managing and/or controlling the CXL host interface hardware 210, among other tasks. In some examples, the HIF management subsystem 216 may handle tasks related to link initialization configuration negotiation with the CXL host 202, error handling, and/or other protocol-specific functionalities. Additionally, or alternatively, the HIF management subsystem 216 may ensure smooth communication between the CXL compliant memory system 204 and/or the CXL host 202, such as by maintaining compatibility and/or reliability of the CXL link, among other examples.

In some examples, the CXL compliant memory system 204 may be categorized as a CXL type 1 device, a CXL type 2 device, or a CXL type 3 device. A CXL type 1 device may be a device that implements a coherent cache using the CXL.cache protocol. A CXL type 2 device may be a device that implements both a coherent cache using the CXL.cache protocol and a host-managed device memory using the CXL.mem protocol. For example, a CXL type 2 device may be a hardware accelerator device. A CXL type 3 device may be a device that implements a host-managed device memory using the CXL.mem protocol. For example, a CXL type 3 device may be a memory expander device.

The number and arrangement of components shown in FIG. 2 are provided as an example. In practice, there may be additional components, fewer components, different components, or differently arranged components than those shown in FIG. 2. Furthermore, two or more components shown in FIG. 2 may be implemented within a single component, or a single component shown in FIG. 2 may be implemented as multiple, distributed components. Additionally, or alternatively, a set of components (e.g., one or more components) shown in FIG. 2 may perform one or more operations described as being performed by another set of components shown in FIG. 2.

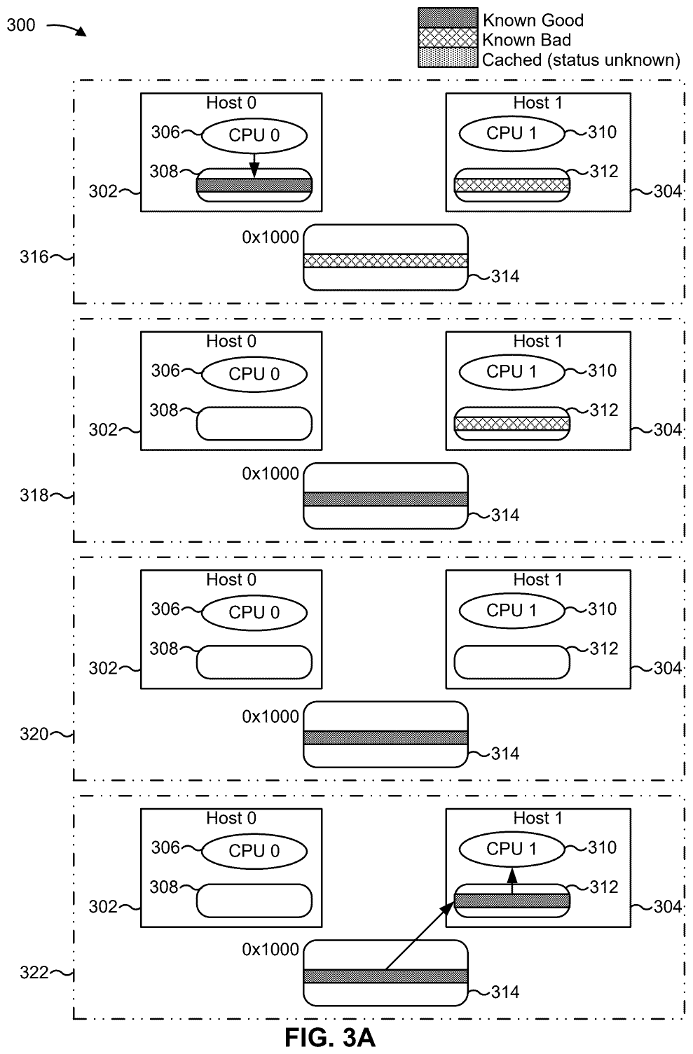

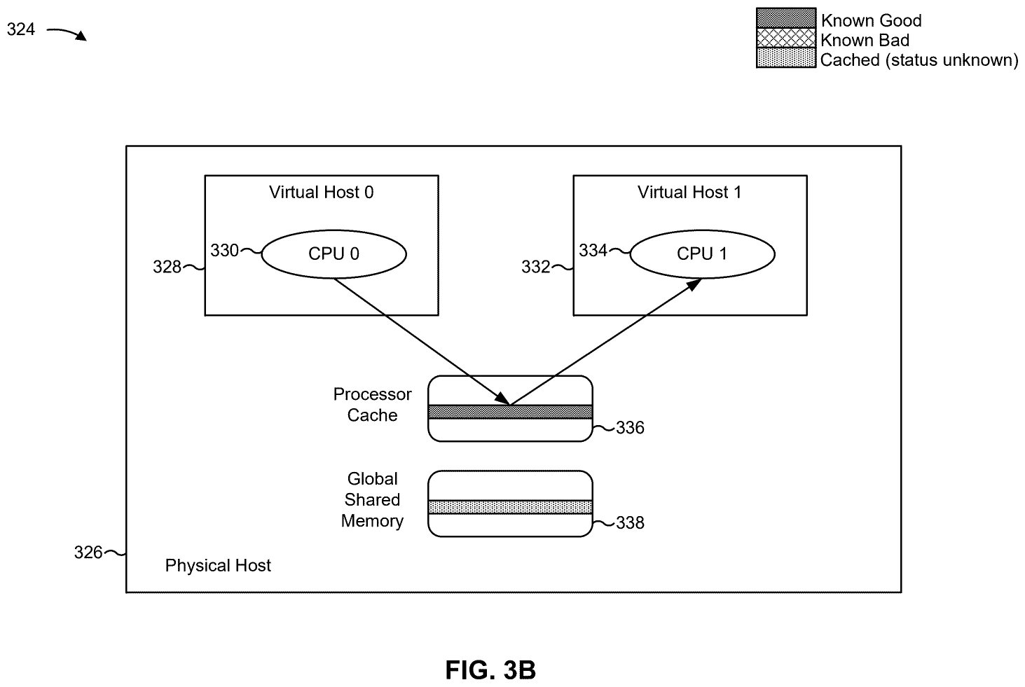

FIGS. 3A-3B are diagrams of examples associated with software coherency primitives for memory systems.

More particularly, FIG. 3A shows an example 300 of a software coherency flow for shared memory clusters, such as CXL-based shared memory clusters or similar shared memory clusters. As shown in FIG. 3A, a shared memory cluster may include multiple host systems in communication with a shared memory medium, such as a CXL device (e.g., CXL compliant memory system 204), among other examples. In such examples, the shared memory cluster may include a first host system 302 (e.g., a first instance of CXL host 202, which is indexed in FIG. 3A as “host 0”) and a second host system 304 (e.g., a second instance of CXL host 202, which is indexed in FIG. 3A as “host 1”). The first host system 302 may include a first CPU 306 (indexed in FIG. 3A as “CPU 0”) and a first processor cache 308. Similarly, the second host system 304 may include a second CPU 310 (indexed in FIG. 3A as “CPU 1”) and a second processor cache 312.

The shared memory cluster may also include a global shared memory 314, which may be a fabric-attached memory (e.g., a CXL fabric-attached memory) or a similar type of memory that is accessible by both the first host system 302 and the second host system 304, such as by using direct access (DAX) protocols, among other examples. Additionally, or alternatively, each host system 302, 304 may map the global shared memory 314 at a same fixed virtual address, such as by using a memory map (mmap) function to establish a mapping between a process's address space and the global shared memory 314, among other examples. For example, in the example shown in FIG. 3A, the first host system 302 and the second host system 304 may mmap the global shared memory 314 at 0x1000, as one example of a fixed virtual address.

As indicated by reference number 316, in some examples the first host system 302 (which, in some examples, may be referred to as a producer and/or may be referred to as including a producer) may store a set of data (schematically shown in FIG. 3A using dark stippling and labeled in FIG. 3A as “known good”) at the global shared memory 314 by transmitting the set of data to the first processor cache 308 and/or by including the fixed virtual address associated with the global shared memory 314 (e.g., 0x1000). As shown in FIG. 3A using cross-hatching (and as labeled in FIG. 3A as “known bad”), at this point in time the data stored in the global shared memory 314 and/or the second processor cache 312 may not match the new data produced at the first host system 302. Put another way, when the first host system 302 produces the new set of data and/or initially stores the new set of data in the first processor cache 308, the new set of data may not be coherent with the data in the global shared memory 314 and/or the second processor cache 312.

Accordingly, the first host system 302 may perform a producer coherency step (e.g., using one or more software coherency primitives), such as for a purpose of rendering the data in the global shared memory 314 coherent with the new set of data stored in the first processor cache 308. More particularly, as indicated by reference number 318, the first host system 302 may perform a flush and/or a fence operation as one example of a producer coherency step, such as for a purpose of forcing the set of data from the first processor cache 308 to the global shared memory 314. At this point in time in the software coherency flow, the data stored in the global shared memory 314 (shown using dark stippling and labeled “known good” to indicate that this is the new set of data produced by the first host system 302) and the data stored in the second processor cache 312 (shown using cross-hatching and labeled “known bad” to indicate that this is the old set of data and not the new set of data produced by the first host system 302) may not match. Put another way, after the first host system 302 forces the data from the first processor cache 308 to the global shared memory 314, the new set of data at the global shared memory 314 may not be coherent with the data stored in the second processor cache 312.

Accordingly, as indicated by reference number 320, the second host system 304 (which, in some examples, may be referred to as a consumer and/or which may be referred to as including a consumer) may perform a consumer coherency step (e.g., using one or more software coherency primitives), such as for a purpose of evicting stale data contained in the second processor cache 312. For example, the second host system 304 may perform a flush and/or a fence operation as one example of a consumer coherency step, such as for a purpose of evicting any stale data from the second processor cache 312. Moreover, as indicated by reference number 322, the second host system 304 may perform a load instruction, such as for a purpose of loading the new set of data from the global shared memory 314 to the second processor cache 312. At this point in time in the software coherency flow, the data stored in the second processor cache 312 and/or the data loaded to the second CPU 310 (shown using dark stippling and labeled “known good” to indicate that this is the new set of data produced by the first host system 302) matches the data stored in the global shared memory 314, resulting in coherent memory access by the first host system 302 and the second host system 304.

Although the correct functionality of software coherency primitives, such as the software coherency primitives associated with the software coherency flow described above in connection with FIG. 3A, may be critical to ensure coherent data among the various host systems in a shared memory cluster, testing of such software coherency primitives in a virtualized environment may be difficult. This is because, in a virtualized environment, hardware coherency may exist for data shared between virtual host systems, and thus correct results may be obtained even if incorrect software coherency primitives are employed and/or even if certain software coherency primitives are omitted. In that regard, it may not be possible to effectively test for correct usage of software coherency primitives in a virtualized environment.

For example, FIG. 3B shows an example 324 of a virtualized environment that may be used to test various aspects of a shared memory cluster (e.g., a CXL shared memory cluster). As shown in FIG. 3B, the virtualized environment may include a physical host 326 running multiple virtual machines to simulate the host systems 302, 304 described above in connection with FIG. 3A. For example, the physical host 326 may include a first virtual host 328 (indexed in FIG. 3B as “virtual host 0”) including a first CPU 330 therein (indexed in FIG. 3B as “CPU 0”), as well as a second virtual host 332 (indexed in FIG. 3B as “virtual host 1”) including a second CPU 334 therein (indexed in FIG. 3B as “CPU 1”). Moreover, the physical host 326 may use a first portion of internal storage to simulate a processor cache 336 (which may correspond to the first processor cache 308 and the second processor cache 312 described above in connection with FIG. 3A) and/or a second portion of internal storage to simulate a global shared memory 338 (which may correspond to the global shared memory 314 described above in connection with FIG. 3A).

In such examples, and in a similar manner as described above in connection with reference number 316, when the producer (e.g., the first virtual host 328) has new data to be stored at the global shared memory 338, the first virtual host 328 may store the set of data at the processor cache 336 (shown in FIG. 3B using dark stippling and labeled “known good”). Although this set of data may ultimately be transferred to the global shared memory 338 using cache-management protocols and/or operations, among other examples, at the point in time shown in FIG. 3B such a transfer may or may not have already occurred (which is indicated by using lighter stippling and labeled “cached (status unknown)” in connection with the global shared memory 338).

Unlike the second host system 304 of the example 300 described above in connection with FIG. 3A, the second virtual host 332 may not need to perform any consumer coherency steps in order to see the new set of data stored at the processor cache 336. This is because the new set of data is already visible to consumers on any virtual host without any coherency operations (e.g., without employing one or more software coherency primitives), because hardware coherency exists by virtue of the virtual hosts 328, 332 and/or the processor cache 336 forming part of the same physical host 326. In that regard, if an application incorrectly omits software coherency primitives, correct results may still be obtained by the second virtual host 332, rendering this virtual environment unsuitable for validating software coherency.

As indicated above, FIGS. 3A-3B are provided as an example. Other examples may differ from what is described with regard to FIGS. 3A-3B.

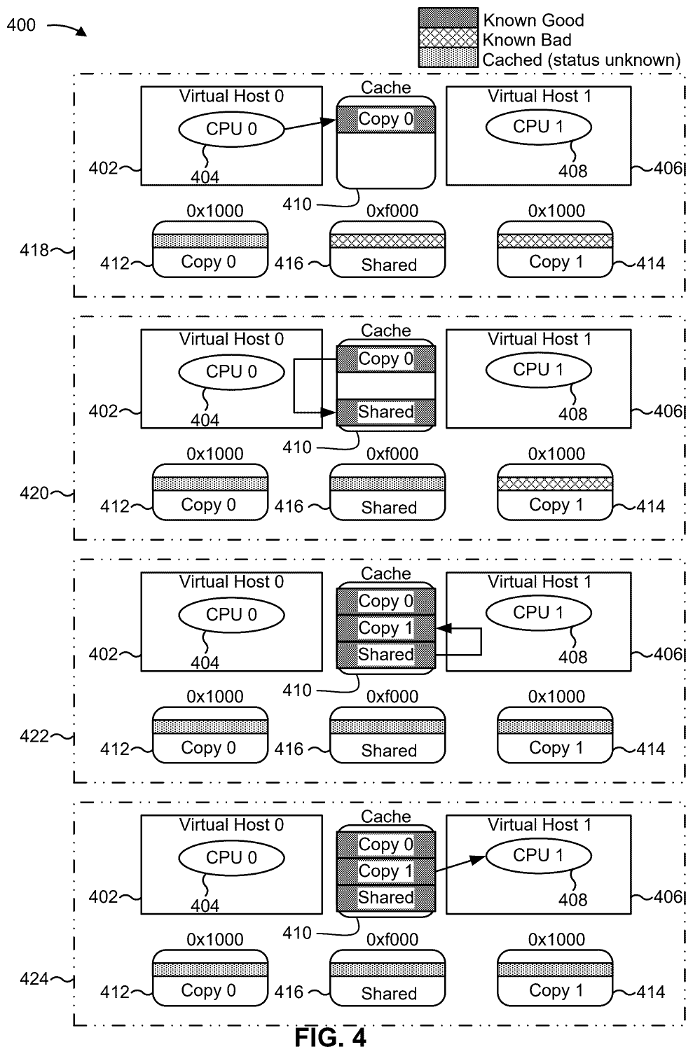

FIG. 4 is a diagram of an example emulation system 400 that may enable emulation of incoherent memory. In some implementations, the emulation system 400 may be referred to as a CXL compliant memory system emulator (e.g., when used to emulate and/or test CXL compliant memory systems), an emulated environment, and/or a similar term. Additionally, or alternatively, the emulation system 400 may be associated with, and/or the operations described in connection with FIG. 4 may be performed by, the host system 105; one or more components of the host system 105, such as the host processor 150; the memory system 110; one or more components of the memory system 110, such as the memory system controller 115, one or more memory devices 120, and/or one or more local controllers 125; the CXL host 202; the CXL compliant memory system 204; and/or or more components of the CXL compliant memory system, such as the main management subsystem 214 and/or the CXL device attached memory 218.

The emulation system 400 may include multiple virtual host system attached to a global shared memory location. For example, in some implementations, the emulation system 400 includes a first virtual host system 402 (indexed in FIG. 4 as “virtual host 0”) including a first CPU 404 therein (indexed in FIG. 4 as “CPU 0”) and a second virtual host system 406 (indexed in FIG. 4 as “virtual host 1”) including a second CPU 408 therein (indexed in FIG. 4 as “CPU 1”). The emulation system 400 may further include one or more storage and/or memory components accessible by the virtual host systems 402, 406, such as a processor cache 410 (sometimes referred to herein simply as a cache for ease of description), a first memory copy location 412 (indexed in FIG. 4 as “copy 0” and sometimes referred to herein as a first local memory location), a second memory copy location 414 (indexed in FIG. 4 as “copy 1” and sometimes referred to herein as a second local memory location), and a shared memory location 416 (sometimes referred to herein as a shared direct-access memory location). In some implementations, including a memory copy location associated with each virtual host system (e.g., the first memory copy location 412 associated with the first virtual host system 402 and the second memory copy location 414 associated with the second virtual host system 406) in addition to a shared memory pool (e.g., the shared memory location 416) may enable emulation of incoherent memory and thus may enable use of the emulation system 400 to test software coherency primitives, among other examples, which is described in more detail below.

In some implementations, the one or one or more storage and/or memory components accessible by the virtual host systems 402, 406 may form part of a same physical device as the virtual host systems 402, 406. Put another way, in some implementations the first virtual host system 402, the second virtual host system 406, the processor cache 410, the first memory copy location 412, the second memory copy location 414, and/or the shared memory location 416 are associated with a same physical device (e.g., a same physical host). In such implementations, the shared memory location 416 may be a simulated DAX memory, among other examples.

In some other implementations, one or more of the storage and/or memory components accessible by the virtual host systems 402, 406 (e.g., the shared memory location 416) may be part of a different physical device than a physical device associated with the virtual host systems 402, 406. Put another way, the first virtual host system 402 and the second virtual host system 406 may be associated with a first physical device, and the shared memory location 416 may be associated with a second physical device different from the first physical device. For example, the first virtual host system 402 and the second virtual host system 406 may be virtual machines operating on a physical host, and/or the shared memory location 416 may be a fabric-attached memory (e.g., a CXL global shared memory presented as a DAX device, among other examples).

In some examples, each virtual host system 402, 406 (more particularly, the corresponding CPU 404, 408 of each virtual host system 402, 406) may map (e.g., mmap) a respective local copy memory location to a same fixed address, such as 0x1000 in the example shown in FIG. 4. More particularly, the first virtual host system 402 may mmap the first memory copy location 412 to the fixed memory address (e.g., 0x1000), and, similarly, the second virtual host system 406 may mmap the second memory copy location 414 to the fixed memory address (e.g., 0x1000). Additionally, or alternatively, each virtual host system 402, 406 (more particularly, the corresponding CPU 404, 408 of each virtual host system 402, 406) may map the shared memory location 416 at a fixed alternate address, such as 0xf000 in the example shown in FIG. 4. More particularly, the first virtual host system 402 and the second virtual host system 406 may mmap the shared memory location to the fixed alternate memory address (e.g., a fixed memory address different from the fixed memory address used for the memory copy locations, such as 0xf000).

As shown by reference number 418, the first virtual host system 402 may store a set of data to the first memory copy location 412. In that regard, in the example shown in FIG. 4, the first virtual host system 402 may be a producer and/or may otherwise be associated with a producer. The first virtual host system 402's store operation may place the set of data into the first virtual host system 402's respective memory space (e.g., the first memory copy location 412), which, as described, may be mapped at a specific address (e.g., 0x1000). Additionally, or alternatively, in some implementations, the first virtual host system 402 may store the set of data to the first memory copy location 412 by transmitting the set of data to the processor cache 410 and/or by using an address of the first memory copy location 412 (e.g., the copy 0 address). In such implementations, although this set of data may ultimately be transferred to the first memory copy location 412 using cache-management protocols and/or operations, among other examples, at the point in time indicated by reference number 418, such a transfer may or may not have already occurred (which is indicated by using lighter stippling and labeled “cached (status unknown)” in connection with the first memory copy location 412). Moreover, because the new set of data has not yet been copied into the shared memory location 416 and/or the second memory copy location 414 at the point in time shown by reference number 418, the data stored in the shared memory location 416 and/or second memory copy location 414 (shown in FIG. 4 using cross-hatching and labeled “known bad”) may not match the new data produced by the first virtual host system 402 and stored in the processor cache 410 and/or the first memory copy location 412. Put another way, when the first virtual host system 402 produces the new set of data and/or initially stores the new set of data in the processor cache 410 and/or the first memory copy location 412 by using the fixed address of the first memory copy location 412 (e.g., 0x1000), the new set of data may not be coherent with the data in the shared memory location 416 and/or the second memory copy location 414.

Accordingly, as indicated by reference number 420, the first virtual host system 402 may perform a producer coherency step (e.g., using one or more software coherency primitives), such as for a purpose of rendering the data in the shared memory location 416 coherent with the new set of data stored in the first memory copy location 412. More particularly, the first virtual host system 402 may copy the data from the first memory copy location 412 to the shared memory location 416, such as by copying the set of data and/or storing the copied set of data in the processor cache 410 at a memory address associated with the shared memory location 416 (e.g., 0xf000). Put another way, to copy the set of data from the first memory copy location 412 to the shared memory location 416, the first virtual host system 402 may copy the set of data from the first portion of the processor cache 410 (e.g., the portion of the cache labeled “copy 0”) to a second portion of the processor cache 410 (e.g., the portion of the cache labeled “shared”). In some implementations, in order to guarantee a correct ordering of the operations described in connection with reference numbers 418 and 420, the first virtual host system 402 may perform a fence operation to ensure that the new set of data is copied to the first memory copy location 412 prior to the data being copied from the first memory copy location 412 to the shared memory location 416.

In such implementations, although this set of data may ultimately be transferred to the shared memory location 416 using cache-management protocols and/or operations, among other examples, at the point in time indicated by reference number 420, such a transfer may or may not have already occurred (which is indicated by using lighter stippling and labeled “cached (status unknown)” in connection with the shared memory location 416). Moreover, because the new set of data has not yet been copied into the second memory copy location 414 at the point in time shown by reference number 420, the data stored in the second memory copy location 414 (shown in FIG. 4 using cross-hatching and labeled “known bad”) may not match the new data stored in the shared memory location 416. Put another way, at a point in time when the first virtual host system 402 copies the new set of data from the first memory copy location 412 to the shared memory location 416, the new set of data may not be coherent with the data stored in the second memory copy location 414.

Accordingly, in some implementations the second virtual host system 406 may perform a consumer coherency step (e.g., using one or more software coherency primitives), such as for a purpose of rendering the data stored in the second memory copy location coherent with the data stored in the shared memory location 416. Additionally, or alternatively, in some aspects, the first virtual host system 402 may set a flag to indicate to the second virtual host system 406 that the set of data is ready to be copied (e.g., to indicate that the second virtual host system 406 should perform the consumer coherency step). For example, the first virtual host system 402 may set a flag that acts as a signal to the second virtual host system 406 that the data stored at the shared memory location 416 (as described above in connection with reference number 420) is available for consumption, ensuring coordination between the producer (e.g., the first virtual host system 402) and the consumer (e.g., the second virtual host system 406) in the emulation environment. In such implementations, the second virtual host system 406 may periodically check a status of the flag (sometimes referred to herein as “spinning on the flag”) to see whether the flag has been set. Once set, the second virtual host system 406 may proceed with reading the set of data from the shared memory location 416, which is described in more detail below. Additionally, or alternatively, the first virtual host system 402 may use a fence operation to ensure the set of data is copied from the first memory copy location 412 to the shared memory location 416 prior to setting the flag. That is, because of ordering semantics or otherwise, the consumer (e.g., the second virtual host system 406) may, in some examples, see the flag is set before the data is updated. Accordingly, the producer (e.g., the first virtual host system 402) may use a fence operation between writing the data and setting the flag to ensure correct results.

In some other implementations, the first virtual host system 402 and/or the second virtual host system 406 may use another technique instead of, or else in addition to, the flag technique described above in order to determine that the produced data is ready for consumption. For example, in some implementations, the first virtual host system 402 and/or the second virtual host system 406 may use an out-of-bands communications channel (e.g., interrupts, events, network communications, and/or the like) to signal that the produced data is ready for consumption. Additional techniques may be implemented by the first virtual host system 402 and/or the second virtual host system 406 to determine that the produced data is ready for consumption without departing from the scope of the disclosure.

Once the second virtual host system 406 determines that the flag has been set, among other examples, the second virtual host system 406 may copy the set of data from the shared memory location 416 to the second memory copy location 414, as shown by reference number 422. For example, upon detecting the flag has been set by the first virtual host system 402, the second virtual host system 406 may perform a consumer coherency step (e.g., using one or more software coherency primitives) in which the second virtual host system 406 copies the set of data from the shared memory location 416 to the second virtual host system 406's local copy location (e.g., the second memory copy location 414). As shown in FIG. 4, the second virtual host system 406 may copy the set of data from the shared memory location 416 to the second memory copy location 414 by copying the set of data from the second portion of the processor cache 410 (e.g., the portion of the cache labeled “shared”) to a third portion of the processor cache 410 (e.g., the portion of the cache labeled “copy 1”). In such implementations, although this set of data may ultimately be transferred to the second memory copy location 414 using cache-management protocols and/or operations, among other examples, at the point in time indicated by reference number 422, such a transfer may or may not have already occurred (which is indicated by using lighter stippling and labeled “cached (status unknown)” in connection with the second memory copy location 414).

In some implementations, as shown by reference number 424, the second virtual host system 406 may load the set of data from the second memory copy location 414 into the second CPU 408 (e.g., CPU 1) associated with the second virtual host system 406. For example, after copying the data to the second virtual host system 406's local memory space (e.g., the second memory copy location 414), the second virtual host system 406 may read (e.g., using a load access) the data from the local memory for processing or further actions, thereby completing the transfer of data across a shared memory environment that includes emulated incoherency.

In some implementations, the emulation system 400 may determine whether one or more software coherency primitives have been omitted and/or include errors based on comparing the set of data loaded from the second memory copy location 414 (e.g., as described above in connection with reference number 424) with the set of data stored to the first memory copy location 412 (e.g., as described above in connection with reference number 418). For example, the emulation system 400 may perform a comparison of the data to verify whether the software-based coherency mechanisms have been executed correctly. In some implementations, any discrepancies between the data loaded at the second CPU 408 from the second memory copy location 414 and the set of data copied to the first memory copy location 412 by the first CPU 404 may indicate that one or more software coherency primitives are missing and/or are not working as intended. Put another way, the emulation system 400 may be capable of determining that one or more software coherency primitives, which are associated with an application that produces correct results when implemented across a hardware coherent memory cluster, include errors based on comparing the set of data loaded from the second memory copy location 414 with the set of data stored to the first memory copy location 412, thereby providing a robust environment for testing software coherency when using hardware-coherent testing environments.

As indicated above, FIG. 4 is provided as an example. Other examples may differ from what is described with regard to FIG. 4.

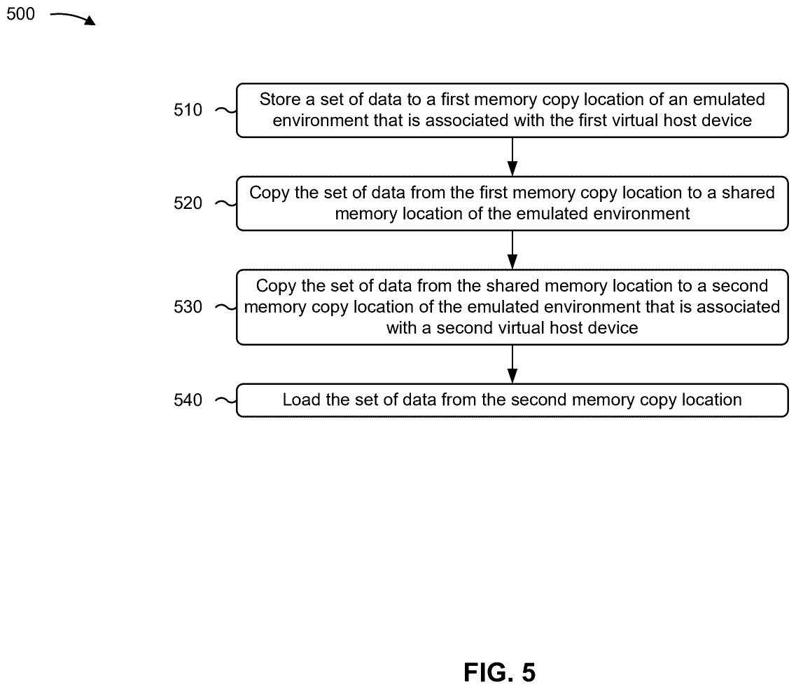

FIG. 5 is a flowchart of an example method 500 associated with techniques and systems for emulating incoherent memory. In some implementations, an emulation system (e.g., the emulation system 400) may perform or may be configured to perform the method 500. In some implementations, another device or a group of devices separate from or including the emulation system (e.g., the host system 105, the host processor 150, the memory system 110, the memory system controller 115, one or more memory devices 120, one or more local controllers 125, the CXL host 202, the CXL compliant memory system 204, the main management subsystem 214, and/or the CXL device attached memory 218) may perform or may be configured to perform the method 500. Additionally, or alternatively, one or more components of the emulation system (e.g., the first virtual host system 402, the first CPU 404, the second virtual host system 406, and/or the second CPU 408) may perform or may be configured to perform the method 500. Thus, means for performing the method 500 may include the emulation system and/or one or more components of the emulation system. Additionally, or alternatively, a non-transitory computer-readable medium may store one or more instructions that, when executed by the emulation system, cause the emulation system to perform the method 500.

As shown in FIG. 5, the method 500 may include storing a set of data to a first memory copy location of an emulated environment that is associated with a first virtual host system (block 510). For example, the first virtual host system 402 (e.g., the first CPU 404 of the first virtual host system 402) may store a set of data to the first memory copy location 412, such as by storing the data in the processor cache 410 using the memory address associated with the first memory copy location 412 (e.g., 0x1000), as described above in connection with reference number 418.

As further shown in FIG. 5, the method 500 may include copying the set of data from the first memory copy location to a shared memory location of the emulated environment (block 520). For example, the first virtual host system 402 (e.g., the first CPU 404 of the first virtual host system 402) may copy the set of data from the first memory copy location 412 to the shared memory location 416, such as by copying the data to the processor cache 410 using the memory address associated with the shared memory location 416 (e.g., 0xf000), as described above in connection with reference number 420.

As further shown in FIG. 5, the method 500 may include copying the set of data from the shared memory location to a second memory copy location of the emulated environment that is associated with a second virtual host system (block 530). For example, the second virtual host system 406 (e.g., the second CPU 408 of the second virtual host system 406) may copy the set of data from the shared memory location 416 to the second memory copy location 414, such as by copying the data to the processor cache 410 using the memory address associated with the second memory copy location 414 (e.g., 0x1000), as described above in connection with reference number 422.

As further shown in FIG. 5, the method 500 may include loading the set of data from the second memory copy location (block 540). For example, the second virtual host system 406 (e.g., the second CPU 408 of the second virtual host system 406) may load the set of data at the second CPU 408, such as by loading the data from the processor cache 410 using the memory address associated with the second memory copy location 414 (e.g., 0x1000), as described above in connection with reference number 424.

The method 500 may include additional aspects, such as any single aspect or any combination of aspects described below and/or described in connection with one or more other methods or operations described elsewhere herein.

In a first aspect, the method 500 includes determining that one or more software coherency primitives associated with the emulated environment include errors based on comparing the set of data loaded from the second memory copy location with the set of data stored to the first memory copy location, wherein the software coherency primitives are associated with an application that produces correct results when implemented across a hardware coherent memory cluster. For example, the emulation system may determine whether one or more software coherency primitives associated with the emulated environment include errors based on comparing the set of data loaded from the second memory copy location 414 by the second virtual host system 406 with the set of data stored to the first memory copy location 412 by the first virtual host system 402.

In a second aspect, alone or in combination with the first aspect, storing the set of data to the first memory copy location includes storing the set of data to a first portion of a cache of the emulated environment, copying the set of data from the first memory copy location to the shared memory location includes copying the set of data from the first portion of the cache to a second portion of the cache, copying the set of data from the shared memory location to the second memory copy location includes copying the set of data from the second portion of the cache to a third portion of the cache, and loading the set of data from the second memory copy location includes loading the set of data from the third portion of the cache to a central processing unit of the second virtual host system. For example, as described above in connection with reference numbers 418, 420, 422, and 424, the first virtual host system 402 and/or the second virtual host system 406 may perform the software coherency primitives described above by storing the set of data in the processor cache 410, copying the set of data within the processor cache 410, and/or loading the set of data from the processor cache 410.

In a third aspect, alone or in combination with one or more of the first and second aspects, the method 500 includes memory mapping, by the first virtual host system, the first memory copy location to a memory address, and memory mapping, by the second virtual host system, the second memory copy location to the memory address. For example, the first virtual host system 402 may mmap the first memory copy location 412 to a fixed memory address (e.g., 0x1000), and the second virtual host system 406 may similarly mmap the second memory copy location 414 to the fixed memory address (e.g., 0x1000), as described above in connection with FIG. 4.

In a fourth aspect, alone or in combination with one or more of the first through third aspects, the method 500 includes memory mapping, by the first virtual host system and the second virtual host system, the shared memory location to a memory address. For example, the first virtual host system 402 and the second virtual host system 406 may mmap the shared memory location 416 to a fixed alternate memory address (e.g., a fixed memory address different from the fixed memory address used for the memory copy locations, such as 0xf000), as described above in connection with FIG. 4.

In a fifth aspect, alone or in combination with one or more of the first through fourth aspects, storing the set of data to the first memory copy location and copying the set of data from the first memory copy location to the shared memory location includes using a fence operation to store the set of data to the first memory copy location prior to copying the set of data from the first memory copy location to the shared memory location. For example, the first virtual host system 402 may use a fence operation when storing the set of data at the first memory copy location 412 and/or copying the set of data to the shared memory location 416, such as for a purpose of ensuring a correct order of operations in the emulated environment, as described above in connection with reference number 420.

In a sixth aspect, alone or in combination with one or more of the first through fifth aspects, the first virtual host system, the second virtual host system, and the shared memory location are associated with a same physical device. For example, the first virtual host system 402, the second virtual host system 406, and/or the shared memory location 416 may be associated with a same physical device (e.g., a same physical host), with the shared memory location 416 being simulated DAX memory, among other examples, as described above in connection with FIG. 4.

In a seventh aspect, alone or in combination with one or more of the first through sixth aspects, the first virtual host system and the second virtual host system are associated with a first physical device, and the shared memory location is associated with a second physical device different from the first physical device. For example, the first virtual host system 402 and the second virtual host system 406 may be associated with a first physical device (e.g., the first virtual host system 402 and the second virtual host system 406 may be virtual machines operating on a physical host), and the shared memory location 416 may be associated with a second physical device different from the first physical device (e.g., the shared memory location 416 may be a fabric-attached memory, such as a CXL global shared memory presented as a DAX device, among other examples), as described above in connection with FIG. 4.

In an eighth aspect, alone or in combination with one or more of the first through seventh aspects, the method 500 includes setting, by the first virtual host system, a flag that indicates to the second virtual host system that the set of data is ready to be copied, and determining, by the second virtual host system, that the flag has been set by the first virtual host system, wherein copying the set of data from the shared memory location to the second memory copy location includes copying the set of data based on determining that the flag has been set. For example, the first virtual host system 402 may set a flag that indicates to the second virtual host system 406 that the set of data is ready to be copied, and the second virtual host system 406 may periodically check a status of the flag (e.g., the second virtual host system 406 may spin on the flag) to see whether the flag has been set, as described above in connection with reference number 422.

In a ninth aspect, alone or in combination with one or more of the first through eighth aspects, copying the set of data from the first memory copy location to the shared memory location includes using a fence operation to copy the set of data from the first memory copy location to the shared memory location prior to setting the flag. For example, the first virtual host system 402 may use a fence operation to ensure the set of data is copied from the first memory copy location 412 to the shared memory location 416 prior to setting the flag to ensure that the consumer (e.g., the second virtual host system 406) does not see the flag is set before the data is updated, as described above in connection with reference number 422.

Although FIG. 5 shows example blocks of a method 500, in some implementations, the method 500 may include additional blocks, fewer blocks, different blocks, or differently arranged blocks than those depicted in FIG. 5. Additionally, or alternatively, two or more of the blocks of the method 500 may be performed in parallel. The method 500 is an example of one method that may be performed by one or more devices described herein. These one or more devices may perform or may be configured to perform one or more other methods based on operations described herein.

In some implementations, an emulation system includes one or more components configured to: copy, by a first virtual host system, a set of data from a first memory copy location to a shared memory location, wherein the first memory copy location is a memory location associated with the first virtual host system; and copy, by one or more second virtual host systems, the set of data from the shared memory location to one or more second memory copy locations associated with the one or more second virtual host systems.

In some implementations, a method includes storing, by a first virtual host system of an emulated environment, a set of data to a first memory copy location of the emulated environment that is associated with the first virtual host system; copying, by the first virtual host system, the set of data from the first memory copy location to a shared memory location of the emulated environment; copying, by a second virtual host system of the emulated environment, the set of data from the shared memory location to a second memory copy location of the emulated environment that is associated with the second virtual host system; and loading, by the second virtual host system, the set of data from the second memory copy location.

In some implementations, a CXL compliant memory system emulator includes one or more components configured to: store, by a first virtual CXL compliant host, a set of data to a first local memory location associated with the first virtual CXL compliant host; copy, by the first virtual CXL compliant host, the set of data from the first local memory location to a shared direct-access memory location; copy, by a second virtual CXL compliant host, the set of data from the shared direct-access memory location to a second local memory location associated with the second virtual CXL compliant host; and load, by the second virtual CXL compliant host, the set of data from the second local memory location.

The foregoing disclosure provides illustration and description but is not intended to be exhaustive or to limit the implementations to the precise forms disclosed. Modifications and variations may be made in light of the above disclosure or may be acquired from practice of the implementations described herein.

Even though particular combinations of features are recited in the claims and/or disclosed in the specification, these combinations are not intended to limit the disclosure of implementations described herein. Many of these features may be combined in ways not specifically recited in the claims and/or disclosed in the specification. For example, the disclosure includes each dependent claim in a claim set in combination with every other individual claim in that claim set and every combination of multiple claims in that claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

When “a component” or “one or more components” (or another element, such as “a controller” or “one or more controllers”) is described or claimed (within a single claim or across multiple claims) as performing multiple operations or being configured to perform multiple operations, this language is intended to broadly cover a variety of architectures and environments. For example, unless explicitly claimed otherwise (e.g., via the use of “first component” and “second component” or other language that differentiates components in the claims), this language is intended to cover a single component performing or being configured to perform all of the operations, a group of components collectively performing or being configured to perform all of the operations, a first component performing or being configured to perform a first operation and a second component performing or being configured to perform a second operation, or any combination of components performing or being configured to perform the operations. For example, when a claim has the form “one or more components configured to: perform X; perform Y; and perform Z,” that claim should be interpreted to mean “one or more components configured to perform X; one or more (possibly different) components configured to perform Y; and one or more (also possibly different) components configured to perform Z.”

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Where only one item is intended, the phrase “only one,” “single,” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. As used herein, the term “multiple” can be replaced with “a plurality of” and vice versa. Also, as used herein, the term “or” is intended to be inclusive when used in a series and may be used interchangeably with “and/or,” unless explicitly stated otherwise (e.g., if used in combination with “either” or “only one of”).

What is claimed is:

1. An emulation system, comprising:
one or more components configured to:
copy, by a first virtual host system, a set of data from a first memory copy location to a shared memory location,
wherein the first memory copy location is a memory location associated with the first virtual host system; and
copy, by one or more second virtual host systems, the set of data from the shared memory location to one or more second memory copy locations associated with the one or more second virtual host systems.

2. The emulation system of claim 1, wherein the one or more components are further configured to load, by the one or more second virtual host systems, the set of data from the one or more second memory copy locations.

3. The emulation system of claim 2, wherein the one or more components are further configured to determine that one or more software coherency primitives associated with the emulation system include errors based on comparing the set of data loaded from the one or more second memory copy locations with the set of data stored to the first memory copy location, and
wherein the software coherency primitives are associated with an application that produces correct results when implemented across a hardware coherent memory cluster.

4. The emulation system of claim 2, wherein the one or more components are further configured to store, by the first virtual host system, the set of data to the first memory copy location,
wherein the one or more components, to store the set of data to the first memory copy location, are configured to store the set of data to a first portion of a cache,
wherein the one or more components, to copy the set of data from the first memory copy location to the shared memory location, are configured to copy the set of data from the first portion of the cache to a second portion of the cache,
wherein the one or more components, to copy the set of data from the shared memory location to the one or more second memory copy locations, are configured to copy the set of data from the second portion of the cache to a third portion of the cache, and
wherein the one or more components, to load the set of data from the one or more second memory copy locations, are configured to load the set of data from the third portion of the cache to a central processing unit of the one or more second virtual host systems.

5. The emulation system of claim 1, wherein the one or more components are further configured to:
memory map, by the first virtual host system, the first memory copy location to a memory address; and
memory map, by the one or more second virtual host systems, the one or more second memory copy locations to the memory address.

6. The emulation system of claim 1, wherein the one or more components are further configured to memory map, by the first virtual host system and the one or more second virtual host systems, the shared memory location to a memory address.

7. The emulation system of claim 1, wherein the one or more components, to copy the set of data from the first memory copy location to the shared memory location, are configured to use a fence operation to store the set of data to the first memory copy location prior to copying the set of data from the first memory copy location to the shared memory location.

8. The emulation system of claim 1, wherein the first virtual host system, the one or more second virtual host systems, and the shared memory location are associated with a same physical device.

9. The emulation system of claim 1, wherein the first virtual host system and the one or more second virtual host systems are associated with a first physical device, and
wherein the shared memory location is associated with a second physical device different from the first physical device.

10. The emulation system of claim 1, wherein the one or more components are further configured to:
set, by the first virtual host system, a flag that indicates to the one or more second virtual host systems that the set of data is ready to be copied; and
determine, by the one or more second virtual host systems, that the flag has been set by the first virtual host system,
wherein the one or more components, to copy the set of data from the shared memory location to the one or more second memory copy locations, are configured to copy the set of data based on determining that the flag has been set.

11. The emulation system of claim 10, wherein the one or more components, to copy the set of data from the first memory copy location to the shared memory location, are configured to use a fence operation to copy the set of data from the first memory copy location to the shared memory location prior to setting the flag.

12. A method, comprising:
storing, by a first virtual host system of an emulated environment, a set of data to a first memory copy location of the emulated environment that is associated with the first virtual host system;
copying, by the first virtual host system, the set of data from the first memory copy location to a shared memory location of the emulated environment;
copying, by a second virtual host system of the emulated environment, the set of data from the shared memory location to a second memory copy location of the emulated environment that is associated with the second virtual host system; and
loading, by the second virtual host system, the set of data from the second memory copy location.

13. The method of claim 12, further comprising determining that one or more software coherency primitives associated with the emulated environment include errors based on comparing the set of data loaded from the second memory copy location with the set of data stored to the first memory copy location,
wherein the software coherency primitives are associated with an application that produces correct results when implemented across a hardware coherent memory cluster.

14. The method of claim 12, wherein storing the set of data to the first memory copy location includes storing the set of data to a first portion of a cache of the emulated environment,
wherein copying the set of data from the first memory copy location to the shared memory location includes copying the set of data from the first portion of the cache to a second portion of the cache,
wherein copying the set of data from the shared memory location to the second memory copy location includes copying the set of data from the second portion of the cache to a third portion of the cache, and
wherein loading the set of data from the second memory copy location includes loading the set of data from the third portion of the cache to a central processing unit of the second virtual host system.

15. The method of claim 12, further comprising:
memory mapping, by the first virtual host system, the first memory copy location to a memory address; and
memory mapping, by the second virtual host system, the second memory copy location to the memory address.

16. The method of claim 12, further comprising memory mapping, by the first virtual host system and the second virtual host system, the shared memory location to a memory address.

17. The method of claim 12, wherein storing the set of data to the first memory copy location and copying the set of data from the first memory copy location to the shared memory location includes using a fence operation to store the set of data to the first memory copy location prior to copying the set of data from the first memory copy location to the shared memory location.

18. The method of claim 12, wherein the first virtual host system, the second virtual host system, and the shared memory location are associated with a same physical device.

19. The method of claim 12, wherein the first virtual host system and the second virtual host system are associated with a first physical device, and
wherein the shared memory location is associated with a second physical device different from the first physical device.

20. The method of claim 12, further comprising:
setting, by the first virtual host system, a flag that indicates to the second virtual host system that the set of data is ready to be copied; and
determining, by the second virtual host system, that the flag has been set by the first virtual host system,
wherein copying the set of data from the shared memory location to the second memory copy location includes copying the set of data based on determining that the flag has been set.

21. A compute express link (CXL) compliant memory system emulator, comprising:
one or more components configured to:
store, by a first virtual CXL compliant host, a set of data to a first local memory location associated with the first virtual CXL compliant host;
copy, by the first virtual CXL compliant host, the set of data from the first local memory location to a shared direct-access memory location;
copy, by a second virtual CXL compliant host, the set of data from the shared direct-access memory location to a second local memory location associated with the second virtual CXL compliant host; and
load, by the second virtual CXL compliant host, the set of data from the second local memory location.

22. The CXL compliant memory system emulator of claim 21, wherein the one or more components are further configured to determine that one or more software coherency primitives associated with the CXL compliant memory system emulator include errors based on comparing the set of data loaded from the second local memory location with the set of data stored to the first local memory location,
wherein the software coherency primitives are associated with an application that produces correct results when implemented across a hardware coherent memory cluster.

23. The CXL compliant memory system emulator of claim 21, wherein the one or more components are further configured to:
memory map, by the first virtual CXL compliant host, the first local memory location to a first memory address;
memory map, by the second virtual CXL compliant host, the second local memory location to the first memory address; and
memory map, by the first virtual CXL compliant host and the second CXL compliant host, the shared direct-access memory location to a second memory address.

24. The CXL compliant memory system emulator of claim 21, wherein the first virtual CXL compliant host, the second virtual CXL compliant host, and the shared direct-access memory location are associated with a same physical device.

25. The CXL compliant memory system emulator of claim 21, wherein the first virtual CXL compliant host and the second virtual CXL compliant host are associated with a first physical device, and
wherein the shared direct-access memory location is associated with a second physical device different from the first physical device.
